(19) United States
(12) Patent Application Publication
(10) Pub. No.: US 2014/0061312 A1
(43) Pub. Date: Mar. 6, 2014

(54) TOUCH CONTROL BARCODE SCANNER AND BARCODE SCANNING DEVICE HAVING THE SCANNER

(71) Applicant: RIOTEC CO., LTD., New Taipei City (TW)

(72) Inventor: Kai-Yuan TIEN, New Taipei City (TW)

(73) Assignee: RIOTEC CO., LTD., New Taipei City (TW)

(21) Appl. No.: 13/893,822

(22) Filed: May 14, 2013

(30) Foreign Application Priority Data
Sep. 4, 2012 (TW) 101217044

(51) Int. Cl. G06K 7/10

(52) U.S. Cl. CPC G06K 7/10881
USPC 235/462.33; 235/462.45

(57) ABSTRACT

A touch control barcode scanner, used for being externally connected to an electric connector of a mobile electronic device thereby enabling the mobile electronic device to provide with barcode scanning function, includes: a main body and a scan module and a touch control module electrically connected with each other. The scan module is disposed in the main body and electrically connected to an external connector inserted in the electric connector; the touch control module is disposed in the main body and installed with a touch control panel corresponding to one side board of the main body; the scan module can be actuated for processing scanning merely through gently touching the touch control panel and the touch control module.

### BACKGROUND OF THE INVENTION

1. Field of the Invention

The present invention relates to a barcode scanner, especially to a touch control barcode scanner and a barcode scanning device having the scanner.

2. Description of Related Art

For a mobile electronic device, e.g. a mobile phone, a personal digital assistant (PDA) or a tablet computer, skill people in the art have developed a barcode scanner capable of being externally connected to the mobile electronic device, and as long as the user downloads the corresponding software into the mobile electronic device, the mobile electronic device is enabled to operate the barcode scanner with an external connecting means for achieving the objective of collecting data through inputting via barcode.

A conventional barcode scanner is inserted and electrically connected to an electric connector of the mobile electronic device through an external connector, thereby allowing the mobile electronic device to be in electric communication with the barcode scanner; when the user wants to actuate the scanning operation, he only needs to press a button installed on the barcode scanner.

However, the electric connector is disposed at one side (short side or long side) of the mobile electronic device; when the barcode scanner is externally connected to the mobile electronic device, the barcode scanner is in a suspended state and only supported by the external connector and the electric connector; once the pressing force applied to the button is overly larger or the pressing operation has been processed for a lot of times, the electric connector may be damaged; because the electric connector is used together with other electronic equipment such as a charger, once the electric connector is damaged, other electronic equipment is unable to be in service through the electric connector, either; for example, the charger being unable to be inserted for processing charging is a disadvantage that has already been criticized for a long time. Moreover, after multiple times of pressing, a slit allowing water to permeate may be generated between the button and the barcode scanner, so electric components in the barcode scanner would be damaged. Furthermore, when the electric connector is disposed at the short side of the mobile electronic device, scanning light beams of the barcode scanner are corresponding to the short side of the mobile electronic device, and the user holds the long side of the mobile electronic device, so the mobile electronic device externally connected with the barcode scanner can be easily held with single hand; however, when the electric connector is disposed at the long side of the mobile electronic device, the scanning light beams of the barcode scanner are corresponding to the long side of the mobile electronic device, and the user can only hold the short side of the mobile electronic device, so the mobile electronic device externally connected with the conventional barcode scanner may not be held by single hand, and the button is hard to be pressed by the same hand, thereby causing shortages and inconvenience.

As such, the applicant of the present invention has devoted himself for improving and solving the mentioned shortages and disadvantages.

### SUMMARY OF THE INVENTION

The present invention is to provide a touch control barcode scanner and a barcode scanning device having the scanner, wherein by installing at least a touch control module at one side or two sides or two opposite sides of the barcode scanner and electrically connected to a scan module, the scan module can be actuated for processing scanning merely by using fingers of the user to gently touch the touch control module, thereby preventing an electric connector of a mobile electronic device from being easily damaged, so the objective of solving the mentioned shortages and disadvantages is achieved.

Accordingly, the present invention provides a touch control barcode scanner used for being externally connected to a mobile electronic device, the mobile electronic device is installed with an electric connector, and the touch control barcode scanner includes: a main body including a first side board; a scan module disposed in the main body, wherein the scan module is electrically connected to an external connector opposite to the electric connector; and a first touch control module, disposed in the main body and installed with a first touch control panel, wherein the first touch control panel is corresponding to the first side board, and the first touch control module and the scan module are electrically connected and used for actuating the scan module for processing scanning.

Accordingly, the present invention provides a barcode scanning device used for being externally connected to a mobile electronic device, the mobile electronic device is installed with an electric connector, and the barcode scanning device includes: a main body including a first side board; a scan module disposed in the main body, wherein the scan module is electrically connected to an external connector opposite to the electric connector; a first touch control module, disposed in the main body and installed with a first touch control panel, wherein the first touch control panel is corresponding to the first side board, the first touch control module and the scan module are electrically connected and used for actuating the scan module for processing scanning; a base, installed to the mobile electronic device, and the main body is able to be detachably positioned on the base; and a connecting cable, electrically connected between the scan module and the external connector.

In comparison with the related art, the present invention has advantageous features as follows: with the installation of the first touch control module, the scan module can be actuated for processing scanning merely by using fingers of the user to gently touch the first touch control module, thereby preventing the electric connector of the mobile electronic device from being easily damaged.

### BRIEF DESCRIPTION OF DRAWING

FIG. 1 is a perspective view showing a touch control barcode scanner according to an embodiment of the present invention;

FIG. 2 is a perspective view showing the touch control barcode scanner being viewed from another angle according to an embodiment of the present invention;

FIG. 3 is a schematic view illustrating the touch control barcode scanner being electrically connected to a mobile electronic device according to an embodiment of the present invention;

FIG. 4 is a schematic front view according to FIG. 1;

FIG. 5 is a schematic view showing the touch control barcode scanner according to another embodiment of the present invention;

FIG. 6 is a perspective exploded view showing a barcode scanning device having the scanner according to one another embodiment of the present invention; and

FIG. 7 is a top view showing the assembly of FIG. 6 according to one another embodiment of the present invention.

### DETAILED DESCRIPTION OF THE INVENTION

Preferred embodiments of the present invention will be described with reference to the drawings.

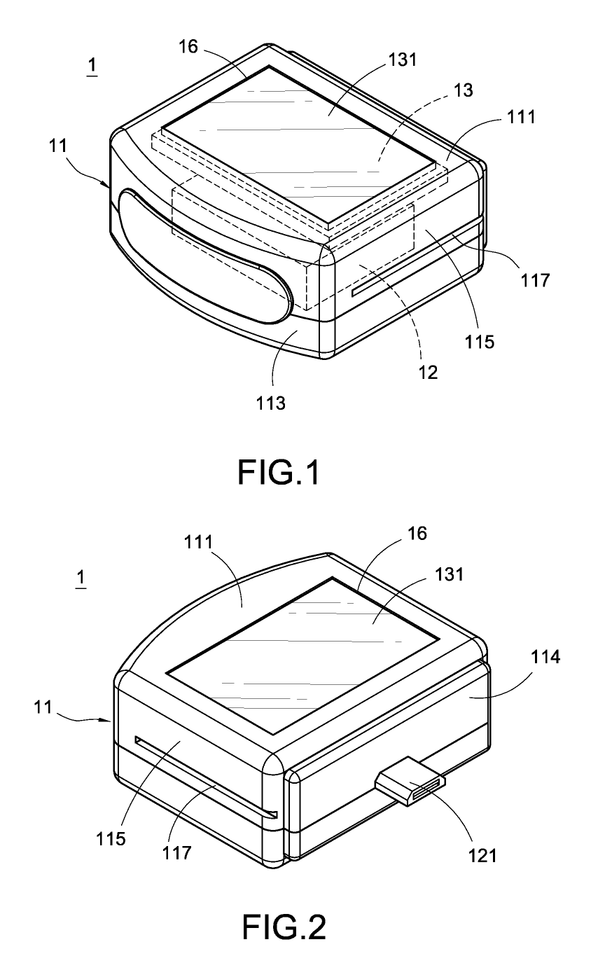

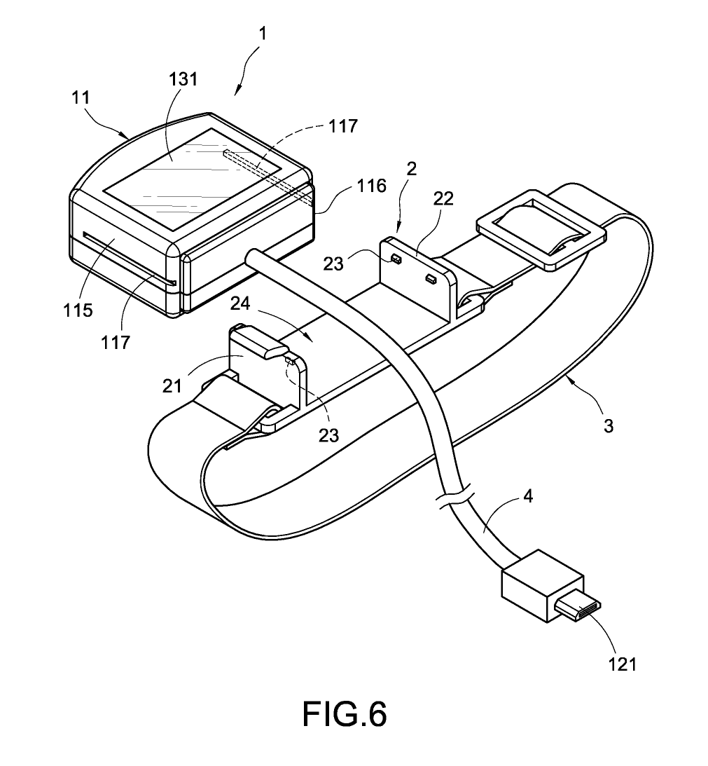

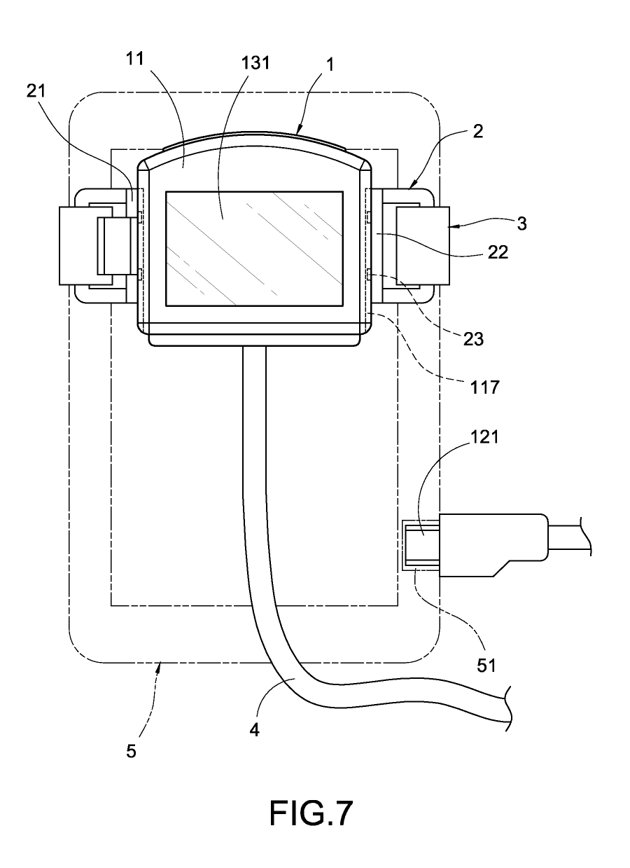

The present invention provides a touch control barcode scanner; please refer from FIG. 1 to FIG. 5, which disclose the touch control barcode scanner provided by the present invention; please refer to FIG. 6 and FIG. 7, which disclose a barcode scanning device provided by the present invention.

As shown from FIG. 1 to FIG. 4, the touch control barcode scanner provided by the present invention is used for being externally and electrically connected to a mobile electronic device 5 (e.g. a mobile phone, a personal digital assistant (PDA) or a tablet computer), and the mobile electronic device 5 can be formed in a rectangular shape having two corresponding long sides and two corresponding short sides and having an electric connector 51 disposed at one of the short sides of the mobile electronic device 5. The touch control barcode scanner 1 includes a main body 11, a scan module 12 and a first touch control module 13.

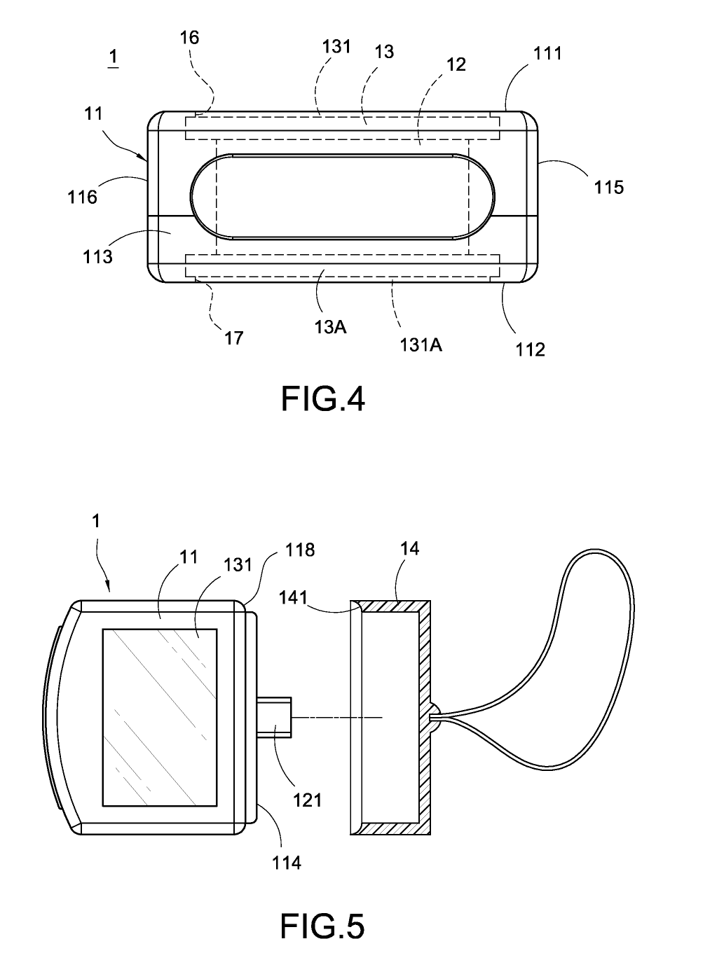

The main body 11 is formed with plural side boards, and the side boards include a first and a second side board 111, 112 corresponding to each other (as shown in FIG. 4), a third and a fourth side board 113, 114 corresponding to each other (as shown in FIG. 1 and FIG. 2) and a fifth and a sixth side board 115, 116 corresponding to each other (as shown in FIG. 4).

The scan module 12 is disposed in the main body 11 and electrically connected to an external connector 121 opposite to the electric connector 51, the external connector 121 is protruded out of the fourth side board 114 of the main body 11, and the external connector 121 is electrically connected to the electric connector 51 with a detachable means. In addition, the scan module 12 is utilized for projecting scanning light beams corresponding to the location where a scanning hole (not provided with a code) is formed on the third side board 113.

The first touch control module 13 is disposed in the main body 11 and installed with a first touch control panel 131, and the first touch control panel 131 is corresponding to the first side board 111 thereby enabling the first touch control panel 131 of the first touch control module 13 to be touch controlled through the first side board 111; as shown in figures, the first side board 111 is formed with a first opening 16, and the first touch control panel 131 of the first touch control module 13 is exposed corresponding to the location of the first opening 16, thereby allowing the first touch control panel 131 of the first touch control module 13 to be directly touch controlled. The two means disclosed above can both achieve the objective of touch controlling, therefore the two means are both within the scope of the present invention.

Because the first touch control module 13 is electrically connected to the scan module 12, the first touch control module 13 is enabled to generate a control signal through being touch controlled, and the control signal can be utilized for actuating the scan module 12 for processing scanning.

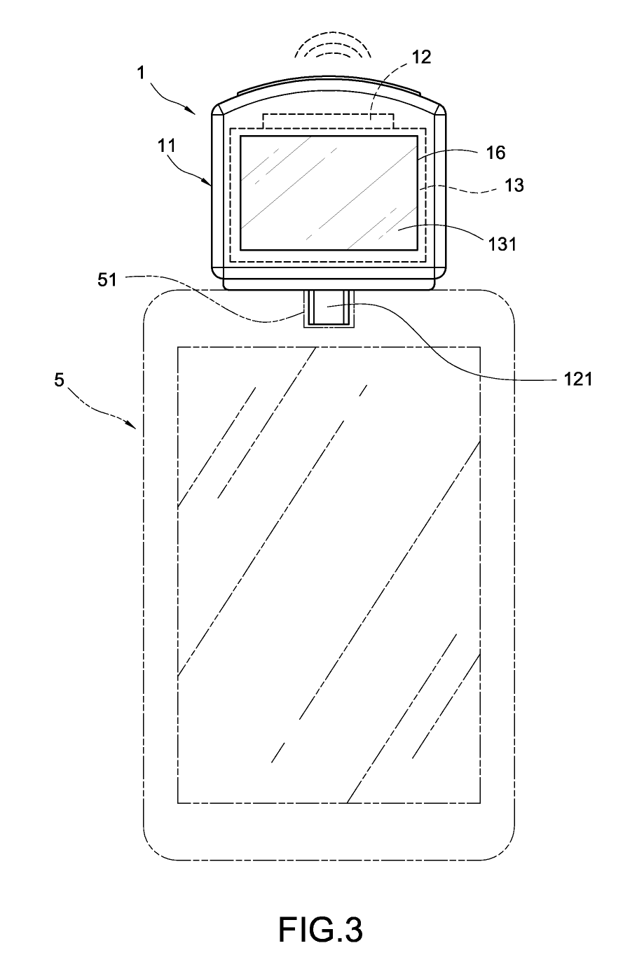

As shown in FIG. 3, the external connector 121 is electrically connected to the electric connector 51, so the touch control barcode scanner 1 is enabled to be externally connected to the mobile electronic device 5 with a plug and play means and electrically connected with each other; at this moment, the touch control barcode scanner 1 is in a suspended state, so in actual operation, a user only needs to use fingers to gently touch the first touch control panel 131 of the first touch control module 13 for generating the required control signal to actuate the scan module 12 for processing scanning, thereby preventing the electric connector 51 of the mobile electronic device 5 from being easily damaged and the scanned data being enabled to store in the mobile electronic device 5. In actual operation, the user uses one hand for holding and uses the same hand for touch controlling the first touch control module 13, and of course the user can use the other hand for touch controlling.

As shown in FIG. 4, the touch control barcode scanner 1 of the present invention further includes a second touch control module 13A having the same configuration as the first touch control module 13 and electrically connected to the scan module 12, the second touch control module 13A is disposed in the main body 11 and installed with a second touch control panel 131A, and the second touch control panel 131A is corresponding to the second side board 112, thereby allowing the second touch control panel 131A of the second touch control module 13A to be touch controlled through the second side board 112; as shown in figures, the second side board 112 is formed with a second opening 17, and the second touch control panel 131A of the second touch control module 13A is exposed corresponding to the location of the second opening 17, thereby allowing the second touch control panel 131A of the second touch control module 13A to be directly touch controlled. Accordingly, when the user uses one hand for holding, fingers of the same hand can gently touch the second touch control module 13A from bottom to top; in details, using the fingers of the hand for touching the second touch control module 13A from bottom to top is smoother in operation comparing to using the fingers of the same hand for touching the first touch control module 13 from top to bottom, and the objective of actuating scanning can also be achieved.

As shown in figures, for increasing the precision of touch controlling through figures, the area of the first touch control panel 131 of the first touch control module 13 and the area of the second touch control panel 131A of the second touch control module 13A can be formed as large as possible, thereby allowing the periphery of the first touch control panel 131 and the periphery of the second touch control panel 131A to be respectively close to the periphery of the first side board 111 and the periphery of the second side board 112 as shown in figures.

As shown in FIG. 5, the touch control barcode scanner 1 of the present invention further includes a cover member 14 covered on the fourth side board 114 of the main body 11, and the cover member 14 is enabled to be detachably covered on the fourth side board 114 of the main body 11 through a connecting member 118 installed on the fourth side board 114 of the main body 11 and a connecting part 141 correspondingly installed on the cover member 14, thereby protecting the external connector 121 exposed out of the fourth side board 114 and preventing the external connector 121 from being damaged due to an external force. In addition, the cover member 14 is provided with a string member (not provided with a code), thereby being easy to be carried by hands, hanged or directly served as a hanging decoration of the mobile electronic device 5.

Please refer to FIG. 6 and FIG. 7, the barcode scanning device having the scanner provided by the present invention is also used for being externally connected to a mobile electronic device 5, and the mobile electronic device 5 can be formed in a rectangular shape having two corresponding long sides and two corresponding short sides, wherein the electric connector 51 is disposed at one of the long sides of the mobile electronic device 5. The barcode scanning device includes a base 2, a connecting cable 4 and the mentioned touch control barcode scanner 1.

The connecting cable 4 is electrically connected between the scan module 12 and the external connector 121 thereby allowing the external connector 121 to be electrically connected to the electric connector 51 located at a farer distance.

The base 2 can be connected to the mobile electronic device 5 with various connecting means, as shown in figures, the base 2 is installed with a fasten member 3 which can be utilized for fastening the base 2 on the mobile electronic device 5, the fasten member 3 can be formed as a binding strip capable of adjusting the binding strength, and the base 2 is disposed between two ends of the binding strip thereby allowing the base 2 to be detachably fastened on the mobile electronic device 5 through adjusting the binding strength of the binding strip as shown in FIG. 7. Wherein, the base 2 includes a first board member 21, a second board member 22 and an accommodation part 24 formed between the first and the second board member 21, 22, opposite inner sides of the first board member 21 and the second board member 22 are respectively formed with two positioning ribs 23, the fifth side board 115 and the sixth side board 116 of the main body 11 are respectively formed with positioning slots 117 corresponding to the positioning ribs 23, and the positioning ribs 23 are enabled to freely slide in the positioning slots 117 thereby allowing the main body 11 to slide in the accommodation part 24, as shown in figures, one end of the positioning slot 117 is formed as opened and the other end thereof is formed as sealed, so during sliding, the main body 11 can still be positioned in the accommodation part 24 through being stopped by the other end.

As shown in FIG. 7, when the electric connector 51 is disposed at the long side of the mobile electronic device 5, for allowing the scanning light beams projected by the touch control barcode scanner 1 to be altered from being corresponding to the original long side of the mobile electronic device 5 to be corresponding to the short side of the mobile electronic device 5 for providing convenience for user holding with single hand and touch controlling with the same hand, as such, while being used, the touch control barcode scanner 1 and the mobile electronic device 5 are mutually fastened via the base 2, so the scanning light beams of the fastened touch control barcode scanner 1 is enabled to be corresponding to the short side of the mobile electronic device 5, then the external connector 121 at the free end of the connecting cable 4 is inserted and electrically connected to the electric connector 51 of the mobile electronic device 5 for being in electrical communication with the mobile electronic device 5; accordingly, the user can use single hand for holding and touch controlling with the same hand.

As what has been disclosed above, in comparison with related art, the present invention has advantageous features as follows: by installing the touch control module (can be the first touch control module 13 or the first and the second touch control module 13, 13A) in the main body 11 and electrically connected to the scan module 12, and the scan module 12 can be actuated for processing scanning merely by using fingers to gently touch the touch control module, thereby preventing the electric connector 51 of the mobile electronic device 5 from being easily damaged; with the installation of the base 2 used for positioning the touch control barcode scanner 1 on the mobile electronic device 5 and the connecting cable 4 used for allowing the external connector 121 to extend out from the main body 11, when the electric connector 51 is disposed at the long side of the mobile electronic device 5, the scanning light beams are enabled to be altered for being corresponding to the short side of the mobile electronic device 5, and the user can still hold the long side of the mobile electronic device 5, so the mobile electronic device 5 externally connected with the touch control barcode scanner 1 can be easily held by single hand and be touch controlled by the fingers of the same hand; moreover, the scan operation can be actuated merely through gently touching via fingers, so the waterproof effect is better than the conventional barcode scanner in which a pressing operation being required thereby causing a slit to be formed, and a waterproof adhesive is preferably to be provided between the first and the second touch control panel 131, 131A and the first and the second opening 16, 17; furthermore, the cover member 14 can be served to protect the external connector 121 from being damaged due to the external force.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A touch control barcode scanner, used for being externally connected to a mobile electronic device, the mobile electronic device being installed with an electric connector, the touch control barcode scanner including:
a main body including a first side board;
a scan module disposed in the main body, wherein the scan module is electrically connected to an external connector opposite to the electric connector; and
a first touch control module disposed in the main body and installed with a first touch control panel, wherein the first touch control panel is corresponding to the first side board, and the first touch control module and the scan module are electrically connected and used for actuating the scan module for processing scanning.

2. The touch control barcode scanner according to claim 1, further including a second touch control module, wherein the second touch control module is disposed in the main body and installed with a second touch control panel, the main body further includes a second side board, the second touch control panel of the second touch control module is corresponding to the second side board, and the second touch control module and the scan module are electrically connected and used for actuating the scan module for processing scanning.

3. The touch control barcode scanner according to claim 2, wherein the first side board of the main body is formed with a first opening, the second side board is formed with a second opening, the first touch control panel of the first touch control module is exposed corresponding to the first opening of the first side board, the second touch control panel of the second touch control module is exposed corresponding to the second opening of the second side board, the main body further includes a third side board formed with a scanning hole, and the scan module projects scanning light beams corresponding to the location where the scanning hole being formed on the third side board.

4. The touch control barcode scanner according to claim 3, wherein the first side board and the second side board of the main body are arranged corresponding to each other.

5. The touch control barcode scanner according to claim 3, wherein the periphery of the first touch control panel of the first touch control module is close to the periphery of the first side board of the main body, and the periphery of the second touch control panel of the second touch control module is close to the periphery of the second side board of the main body.

6. The touch control barcode scanner according to claim 3, further including a cover member, wherein the main body further includes a fourth side board, the cover member is covered on the fourth side board of the main body, the external connector is exposed out of the fourth side board of the main body, and the external connector is covered between the fourth side board of the main body and the cover member.

7. A barcode scanning device, used for being externally connected to a mobile electronic device, the mobile electronic device being installed with an electric connector, the barcode scanning device including:
a main body including a first side board;
a scan module disposed in the main body, wherein the scan module is electrically connected to an external connector opposite to the electric connector;
a first touch control module, disposed in the main body and installed with a first touch control panel, wherein the first touch control panel is corresponding to the first side board, and the first touch control module and the scan module are electrically connected and used for actuating the scan module for processing scanning;
a base, installed to the mobile electronic device, wherein the main body is able to be detachably positioned on the base; and
a connecting cable, electrically connected between the scan module and the external connector.

8. The barcode scanning device according to claim 7, wherein the base is installed with a fasten member, and the base is able to be detachably fastened on the mobile electronic device via the fasten member.

9. The barcode scanning device according to claim 8, wherein the fasten member is a binding strip capable of adjusting the binding strength, the base is disposed between two ends of the binding strip, and the base is fastened on the mobile electronic device through the binding strip.

10. The barcode scanning device according to claim 7, wherein the base includes a first board member, a second board member and an accommodation part formed between the first and the second board member, the first board member and the second board member are respectively formed with at least a positioning rib, the main body further includes a fifth side board and a sixth side board corresponding to each other, the fifth side board and the sixth side board are respectively formed with a positioning slot corresponding to the positioning rib, the two positioning ribs of the base are enabled to respectively slide in the two positioning slots of the main body, and the main body is positioned in the accommodation part of the base through the two positioning ribs sliding in the two positioning slots.

11. The barcode scanning device according to claim 7, further including a second touch control module, wherein the second touch control module is disposed in the main body and installed with a second touch control panel, the main body further includes a second side board, the second touch control panel of the second touch control module is corresponding to the second side board, and the second touch control module and the scan module are electrically connected and used for actuating the scan module for processing scanning.

12. The barcode scanning device according to claim 11, wherein the first side board of the main body is formed with a first opening, the second side board is formed with a second opening, the first touch control panel of the first touch control module is exposed corresponding to the first opening of the first side board, the second touch control panel of the second touch control module is exposed corresponding to the second opening of the second side board, the main body further includes a third side board formed with a scanning hole, and the scan module projects scanning light beams corresponding to the location where the scanning hole being formed on the third side board.

13. The barcode scanning device according to claim 12, wherein the first side board and the second side board of the main body are arranged corresponding to each other.

14. The barcode scanning device according to claim 12, wherein the periphery of the first touch control panel of the first touch control module is close to the periphery of the first side board of the main body, and the periphery of the second touch control panel of the second touch control module is close to the periphery of the second side board of the main body.

15. The barcode scanning device according to claim 12, further including a cover member, wherein the main body further includes a fourth side board, the cover member is covered on the fourth side board of the main body, the external connector is exposed out of the fourth side board of the main body, and the external connector is covered between the fourth side board of the main body and the cover member.
